(19) United States
(12) Patent Application Publication
(10) Pub. No.: US 2022/0414547 A1
(43) Pub. Date: Dec. 29, 2022

(54) MACHINE LEARNING INFERENCING BASED ON DIRECTED ACYCLIC GRAPHS

(71) Applicant: salesforce.com, inc., San Francisco, CA (US)

(72) Inventors: Seyedshahin Ashrafzadeh, Foster City, CA (US); Alexandr Nikitin, El Sobrante, CA (US); Vaibhav Gumashta, San Francisco, CA (US); Yuliya L. Feldman, Campbell, CA (US); Manoj Agarwal, Cupertino, CA (US); Swaminathan Sundaramurthy, Los Altos, CA (US)

(21) Appl. No.: 17/357,312

(22) Filed: Jun. 24, 2021

(51) Int. Cl. G06N 20/20; G06K 9/62

(52) U.S. Cl. CPC G06N 20/20; G06K 9/623; G06K 9/6296

(57) ABSTRACT

Methods and systems for machine learning inferencing based on directed acyclic graphs are presented. A request for a machine learning application is received from a tenant application. A tenant identifier that identifies one of the tenants is determined from the request. Based on the tenant identifier and a type of the machine learning application, configuration parameters and a graph structure are determined. The graph structure defines a flow of operations for the machine learning application. Nodes of the graph structure are executed based on the configuration parameters to obtain a scoring result. Execution of a node causes a machine learning model generated for the first tenant to be applied to data related to the request. The scoring result is returned in response to the request.

### TECHNICAL FIELD

One or more implementations relate to the field of machine learning; and more specifically, to machine learning inferencing based on directed acyclic graphs.

### BACKGROUND ART

Machine learning is a type of artificial intelligence that deals with computer algorithms that automatically improve through experience and/or by the use of data. Machine learning algorithms build a machine learning model (also referred to as a predictive model) based on training data (also referred to as sample data) to make predictions or decisions without being explicitly programmed to do so. A machine learning model may be a representation of what a machine learning algorithm has learned after analyzing training data. Machine learning algorithms are used in a wide variety of applications such as email filtering and computer vision, where it is difficult or unfeasible to develop conventional algorithms to perform the needed tasks. Machine learning algorithms are also used in customer relationship management (CRM) systems to help make business decisions based on customer data.

Machine learning typically involves three phases: feature engineering, training, and scoring (also referred to as predicting or inferencing). Feature engineering involves the use of domain knowledge to extract features such as characteristics, properties, and/or attributes of raw data. The features are used to represent the data in machine learning models. The training phase involves the use of machine learning algorithms to train models (also referred to as prediction models, predictive models, machine learning models, etc.) based on the training data. The scoring phase involves receiving new (unseen) data and generating based on a trained model scoring results (e.g., predictions or inferences) for the new data. For example, based on data received in the request, features for that request are input to a trained model, which returns outcomes in the form of scores (e.g., probability scores for classification problems and estimated averages for regression problems).

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram of a machine-learning serving infrastructure, in accordance with some implementations.

FIG. 2A illustrates a block diagram of a representation of an exemplary flow of operations of a first machine learning application, in accordance with some implementations.

FIG. 2B illustrates a block diagram of a representation of an exemplary flow of operations of a second machine learning application, in accordance with some implementations.

FIG. 3A illustrates a flow diagram of exemplary operations that can be performed in an MLS infrastructure, in accordance with some implementations.

FIG. 3B illustrates a flow of exemplary operations for responding to a request of a machine learning application, in accordance with some implementations.

FIG. 4A illustrates a block diagram of nodes that can be used in a DAG for defining a machine learning application, in accordance with some implementations.

FIG. 4B illustrates a block diagram of an exemplary data serialization language that can be used for creating a graph structure that represents a machine learning application, in accordance with some implementations.

FIG. 4C illustrates an exemplary domain specific language (DSL) for enabling a developer/data scientist to define a machine learning application for a tenant of the MLS infrastructure, in accordance with some implementations.

FIG. 5 illustrates a flow diagram of exemplary operations that can be performed for responding to an on-demand request for a machine learning application when the application is defined according to a graph structure, in accordance with some implementations.

FIG. 6A is a block diagram illustrating an electronic device according to some example implementations.

FIG. 6B is a block diagram of a deployment environment according to some example implementations.

### DETAILED DESCRIPTION

The following description describes implementations for enabling multi-model scoring in a multi-tenant system. Additionally, the following description describes implementations for enabling the machine learning inferencing based on a directed acyclic graph.

Some machine learning infrastructures allow for a definition of a machine learning pipeline. In these standard infrastructures, a machine learning pipeline can include a sequence of two or more sub-elements, where at least one of the elements is a machine learning model. Existing machine learning infrastructures (e.g., Sagemaker, Konduit, Seldon, or Kubelow) provide building blocks for defining ML pipelines. However, these infrastructures are limited as they do not support multi-tenancy. In these systems, each machine learning application is defined with its own endpoint (i.e., there is no support for a single element of the infrastructure to receive requests for multiple tenants). In addition, these infrastructures allow for a static definition of a pipeline and do not allow for any dynamic operations in the pipeline. Another drawback of existing systems is the requirement for containerization of each operation in the pipeline, i.e., each sub-element of the pipeline is executed in a container requiring orchestration and management between these executions.

The implementations described herein address the deficiencies described above by enabling multi-tenancy support in a machine learning application. Further, the implementations herein enable a dynamic, scalable solution for defining a machine learning application based on a directed acyclic graph.

A machine-learning serving infrastructure can be automated and organized to support multi-tenancy where containers can be used to execute machine-learning applications that can serve one or more other applications and/or users of tenants in a multi-tenant system.

In some implementations, the MLS infrastructure supports multi-model machine learning applications. In one implementation, the MLS infrastructure receives from a tenant application a request for a machine learning application. The MLS infrastructure determines a tenant identifier that identifies one of the multiple tenants. The MLS infrastructure determines, based on the tenant identifier and a type of the machine learning application, a first machine learning model that was generated based on a first training data set associated with the tenant identifier and a second machine learning model that was generated based on a second training data set associated with the tenant identifier. The MLS infrastructure executes, based on the type of the machine learning application, a flow of operations that includes running the first and second machine learning models with data related to the request to obtain a scoring result. The MLS infrastructure returns the scoring result to the tenant application in response to the request.

Additionally or alternatively, the MLS infrastructure supports the definition of a flow of operations of a machine learning application based on a directed acyclic graph (DAG) structure. A data scientist/developer can create a new machine learning application or update an existing machine learning application by defining/updating a DAG. In some implementations, the definition of the DAG can be enabled through a domain specific language (DSL). In some implementations, the definition of the DAG can be enabled through a human-readable data-serialization language (e.g., Yet Another Markup Language (YAML) or JavaScript Object Notation (JSON), etc.). The MLS infrastructure receives from a tenant application a request for a first machine learning application. The MLS infrastructure determines, from the request, a tenant identifier that identifies one of the tenants. The MLS infrastructure determines, based on the tenant identifier and a type of the machine learning application, configuration parameters and a graph structure that defines a flow of operations for the machine learning application. The MLS infrastructure executes nodes of the graph structure based on the configuration parameters to obtain a scoring result. The execution of the nodes includes executing a node, based on the configuration parameters, that causes a machine learning model generated for the first tenant to be applied to data related to the request. The MLS infrastructure returns the scoring result in response to the request.

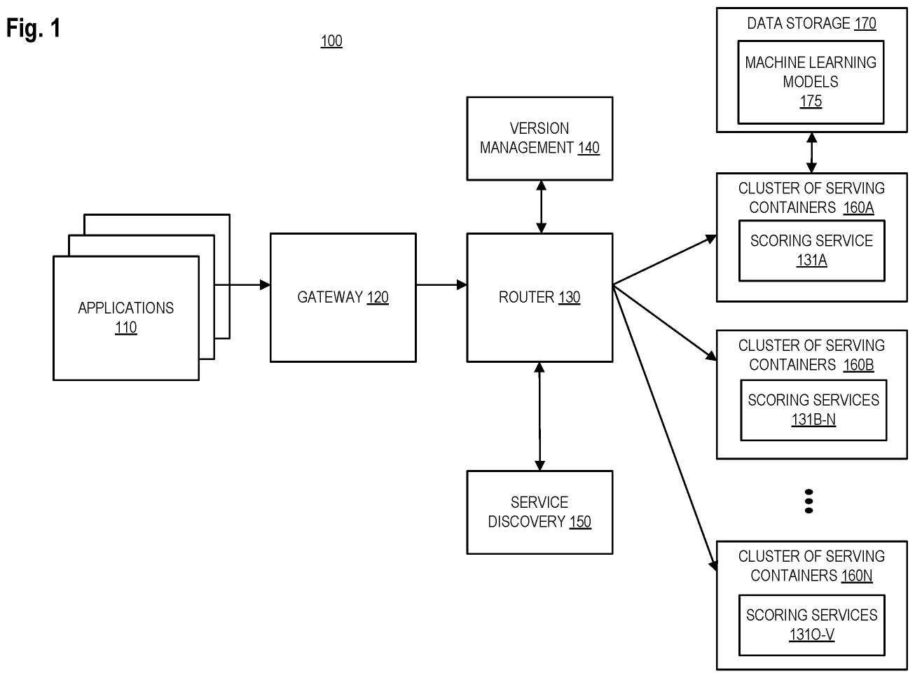

FIG. 1 is a block diagram of a machine-learning serving infrastructure, in accordance with some implementations. The machine-learning serving infrastructure 100 (also referred to herein simply as a “MLS infrastructure”) provides one or more machine learning applications for multiple tenants. The MLS infrastructure can be referred to as a multi-tenant MLS infrastructure.

The MLS infrastructure 100 includes applications 110, a gateway component 120, a router component 130, a version management component 140, a service discovery component 150, a data storage component 170, and clusters of serving containers 160A-C. Each of the components may be implemented using one or more electronic devices.

The applications 110 can be any program or software to perform a set of tasks or operations. A ‘set,’ as used herein includes any positive whole number of items including a single item. The applications are operative to make requests to one or more machine learning applications of the MLS infrastructure 100 and receive scoring results for the requests. Within a multitenant system, an application is designed to provide each tenant with a tenant-specific view of the application including access only to tenant-specific data, configuration, user management, and similar tenant properties and functionality.

In some implementations, the MLS infrastructure 100 includes machine learning applications (not illustrated) that provide one or more scoring services. Additionally or alternatively, the machine learning applications can provide feature engineering and/or training of the machine learning models used in the scoring services. The MLS infrastructure 100 can provide on-demand machine learning applications (also referred to as real time) or batch machine learning applications, which can apply batch scoring. An on-demand machine learning application makes predictions in response to requests that originate from application functions (e.g., from the applications 110) or from user interactions with the applications 110. In contrast to offline/batch predictions, in on-demand recommendations, a current context of the request along with historical information are needed to make the prediction. Batch machine learning applications make predictions for sets of data (typically large sets of data). In a non-limiting example, the MLS infrastructure 100 is operative to receive a request for scoring a business opportunity from a Customer Relationship Management (CRM) application and to identify based on the request a flow of operations of the machine learning application for responding to the request. In other examples, the machine learning application can respond to requests for providing personalized food recommendations, providing estimations for delivery times, predicting an identity of a user based on a conversation with a bot, etc.

The gateway component 120 serves as the entry point for one or more machine learning applications. The gateway component 120 may implement an API that allows an application 110 (also referred to as tenant application) to submit requests to the machine learning applications. In an implementation, the gateway component 120 provides protection against bursty loads, performs Internet Protocol (IP) filtering (e.g., to only allow incoming scoring requests from known hosts), and/or performs various security-related functionality (e.g., to only allow API calls over Hypertext Transfer Protocol Secure (HTTPS)). The gateway component 120 may receive requests from the applications 110 and send the requests to the router component 130 to be routed to the appropriate scoring service 131 or cluster of serving containers 160.

A machine learning application is defined by a flow of operations that includes at least a scoring service. A scoring service, e.g., the services 131A-V, receives scoring requests from the router 130, apply a machine learning model to new data according to the request to generate a scoring result (e.g., predictions/inferences based on the new data). If the machine-learning model is not loaded in the serving container, the machine-learning service 100 loads the machine-learning model in the serving container. If the machine-learning model is loaded in the serving container, the system executes, in the serving container, the machine-learning model on behalf of the scoring request. In some implementations, the scoring result is used as an input to another scoring service before being output by the machine learning application. Additionally or alternatively, the scoring result is output separately or in aggregation with other scoring results by the machine learning application.

A machine-learning model can be a set of algorithms and statistical data structures that can be trained to perform a specific task by identifying patterns and employing inference instead of using explicit instructions. The machine-learning model can be trained for the task using a set of training data. In a multi-tenant system, a machine learning model is associated with a single tenant from the multiple tenants of the MLS infrastructure. A machine learning model that is associated with the single tenant is trained based on tenant specific data and can be used to respond to requests of a scoring service for that tenant. The MLS infrastructure 100 supports a large number of tenants and machine learning models for these tenants. The MLS infrastructure 100 supports high volume/throughput (e.g., it can respond to more than 600 requests per second). For example, when the number of tenants is more than 10,000 tenants and multiple types of models are defined for each tenant, multiple tens of thousands of models need to be supported in the MLS infrastructure 100. A first machine learning model can be one of multiple types. A machine learning model can be generated by training a model of a first type with tenant specific data of a given tenant. A second machine learning model can be generated by training the model of the same type with tenant specific data of another tenant. A third machine learning model can be generated by training a model of a different type with tenant specific data of the first tenant.

A serving container in a cluster of serving containers can be an isolated execution environment that is enabled by an underlying operating system, and which executes the main functionality of a program such as a scoring service. A serving container can host any number of scoring services for any number of tenants. Serving containers can be organized as a cluster, e.g., clusters 160A-N. The cluster can be a group of similar entities, such that a cluster of serving containers can be a group of serving container instances or similar grouping. The MLS infrastructure 100 can host any number of serving containers or clusters of serving containers 160A-N. Different clusters can host different versions or types of scoring services or different versions or types of combinations of scoring services 131A-V. In some implementations, a serving container (or container) is a logical packaging in which applications can execute that is abstracted from the underlying execution environment (e.g., the underlying operating system and hardware). Applications that are containerized can be quickly deployed to many target environments including data centers, cloud architectures, or individual workstations. The containerized applications do not have to be adapted to execute in these different execution environments as long as the execution environment supports containerization. The logical packaging includes a library and similar dependencies that the containerized application needs to execute. However, containers do not include the virtualization of the hardware of an operating system. The execution environments that support containers include an operating system kernel that enables the existence of multiple isolated user-space instances. Each of these instances is a container. Containers can also be referred to as partitions, virtualization engines, virtual kernels, jails, or similar terms.

In some implementations, each of the serving containers registers with a service discovery system 150 by providing the serving container's registration information, such as the host, the port, functions, or similar information. When any of the serving containers is no longer available or becomes unavailable, the service discovery system 150 deletes the unavailable serving container's registration information. An available serving container can be referred to as an actual serving container.

The service discovery system 150 can be implemented by HashiCorp Consul, Apache Zookeeper, Cloud Native Computing Foundation etcd, Netflix eureka, or any similar tool that provides service discovery and/or a service registration system. The service discovery system 150 can track container information about each serving container and model information about each serving container's scoring service. In other implementations, this information can be stored in other locations such as a datastore. Container information can be data about an isolated execution environment, which executes the main functionality of a scoring service that uses a machine-learning model. Model information can be data about the algorithms and/or statistical models that perform a specific task effectively by relying on patterns and inference instead of using explicit instructions. Model information can include a model identifier. The identifier of a model identifies a model of a given type that is trained based on tenant specific training data.

The router 130 implements a routing service that receives requests of the tenant application (through the gateway 120) for a machine learning application, and then routes the request for service according to the machine learning application in the MLS infrastructure 100. The router 130 can be implemented as a set of routing containers, or a cluster of routing containers, each implementing instances of the routing service functions or subsets of these functions. In some implementations, the router 130 can split the incoming request into separate sub-requests, and then route the sub-requests to their corresponding clusters 160A-V of serving containers. Although some examples describe the clusters of serving containers that serve one version of a scoring service 131A, one version or more version of scoring services 131B-B, and scoring services 1310-V, any clusters of any serving containers may serve any number of versions of any number of any types of any machine-learning models 175.

The router 130 can be deployed with multiple redundant and/or distributed instances so that it is not a single point of failure for the machine-learning serving infrastructure 100. In some implementations, one instance of the router 130 acts as a master, while other instances of the router 130 are in a hot standby mode, ready to take over if the master instance of the router fails or to perform some operations at the direction of the master instance.

The router 130 makes decisions to load, rebalance, delete, distribute, and replicate the scoring services 131 in the serving containers 160A-N. These decisions can be based on the information provided to the router 130 by the serving containers 160A-N and other elements of the MLS infrastructure 100. The data model information in the service discovery system 150 provides information about which serving containers are expected to host-specific machine-learning models and which serving containers actually host the specified machine-learning models. The router 130 can also send a list of expected machine-learning models to a model mapping structure in the service discovery system 150. Each of the serving containers 160A-N can manage a list of executing scoring services that are associated with respective machine-learning models. If the serving container cache does not match the list of expected machine-learning models that a serving container receives, the serving container can load or delete any machine-learning models as needed, and then update its cache of executing machine-learning models accordingly. The router 130 can monitor and maintain each serving container's list of actual machine-learning models to determine where to route requests. In some implementations, the MLS infrastructure 100 can include any number of additional supporting features and functions, which are not illustrated.

Multi-Model Support in a Multi-Tenant Environment

In some implementations, the MLS infrastructure 100 is operative to support multi-model machine learning applications. A multi-model machine learning application is an application that runs at least two separate machine learning models for responding to a request from a tenant application. The machine learning application defines a flow of operations that includes the multiple machine learning models. In some implementations, the flow of operations can combine the machine learning models in sequence, where an output of a first model is fed to the next model in the sequence. Alternatively or additionally, the flow of operations can combine the machine learning models based on parallel independent executions of the machine learning models. In some implementations, the multi-model machine learning application implements an ensemble modeling process. In ensemble modeling multiple diverse models are created to predict a single outcome, either by using many different modeling algorithms or using different training data sets for the same algorithm. The ensemble model then aggregates the prediction of each base model and results in one final prediction for the unseen data. For example, multiple models can be used to predict a date of failure of a product sold to a customer in a CRM application, and the results of these models are aggregated and analyzed to produce a single date of failure of the product. In other implementations, the multi-model machine learning application uses independent models to predict different outcomes. These outcomes can be aggregated and presented in a list in response to a request to the MLS infrastructure. For example, a first model can be used to predict a date of failure of a product sold to a customer in a CRM application, a second model can be used to predict the likelihood that the customer will request a replacement of the product. These two different predictions are output in response to a single request, however, they are presented separately.

In one implementation, the MLS infrastructure 100 receives from a tenant application a request of a machine learning application. The request is sent to the router 130, which determines a tenant identifier that identifies one of the multiple tenants of the MLS infrastructure 100. The router 130 determines, based on the tenant identifier and a type of the machine learning application, a first machine learning model that was generated based on a first training data set associated with the tenant identifier and a second machine learning model that was generated based on a second training data set associated with the tenant identifier. The router 130 executes, based on the type of the machine learning application, a flow of operations that includes running the first and second machine learning models with data related to the request to obtain a scoring result. The data related to the request can be data included in the request or data retrieved from one or more data storage systems in the MLS infrastructure 100 based on one or more fields of the request. The MLS infrastructure 100 returns the scoring result to the tenant application in response to the request. In some implementations, when a request for a different tenant and the same application is received in the MLS infrastructure 100, the same flow of operations is performed by the router 130 with different models specific to the different tenant. In some implementations, when a request for the same tenant and a different application is received, a different flow of operations is performed with potentially the same or different models.

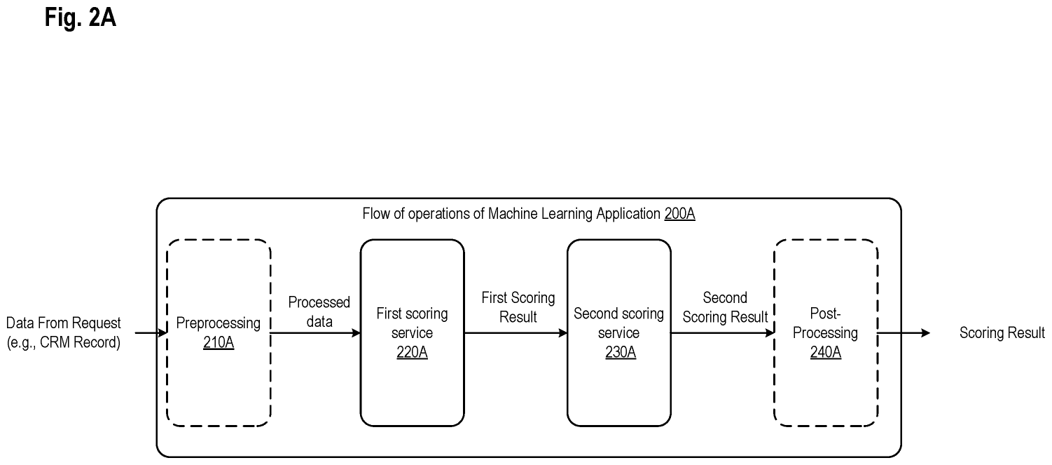

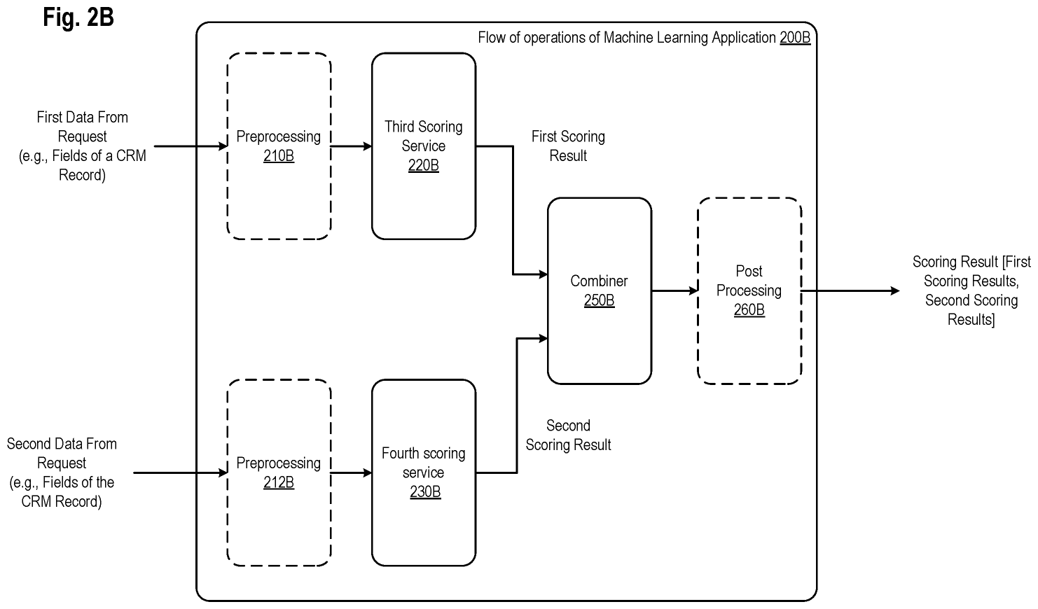

FIG. 2A illustrates a block diagram of a representation of an exemplary flow of operations 200A of a first machine learning application, in accordance with some implementations. The flow of operations 200A includes a sequence of elements 210A, 220A, 230A, and 240A, where each element represents operations that would be performed in response to a request for the first machine learning application. A first element 210A represents a preprocessing operation. The preprocessing operation 210A receives data related to the request as input, performs one or more operations on the data, and outputs processed data. In some implementations, preprocessing the data includes preparing the data for the first scoring service 220A. For example, the preprocessing can include extracting from the data related to the request features that can be used in a first machine learning model of the first scoring service 220A to obtain a first scoring result. Additionally or alternatively, the processing can include retrieving from one or more data stores (e.g., tenant database) the features to be used in the first machine learning model based on data included in the request. The second element 220A represents a first scoring service. The first scoring service is associated with a first type of machine learning model. The first scoring service 220A receives the processed data as input and uses the first machine learning model to obtain a first scoring result. The third element 230A represents a second scoring service. The second scoring service is associated with a second type of machine learning models. The second scoring service 230A receives data based on the output of the first scoring service and uses a machine learning model of the second type to obtain a second scoring result. The data that is fed to the second scoring service 230A can be the output of the first scoring service 220A or a modified version of this output. The modified version of the output of the first scoring service 220A includes features to be used by the second machine learning model to make a prediction. The fourth element 240A represents a postprocessing operation. The post processing operation 240A receives data based on the output of the second scoring result, performs one or more operations on the data, and outputs a scoring result that is to be returned to the tenant application in response to the request. In some implementations, the preprocessing and postprocessing elements are optional. The flow of operations 200A presents an example of machine learning applications where two scoring services are used in sequence. The output of the first scoring service (that is determined by running a first machine learning model) is used in the second scoring service to determine a scoring result for the machine learning applications. While the exemplary flow 200A includes two scoring services, in other examples, additional scoring services and/or operations can be included.

FIG. 2B illustrates a block diagram of a representation of an exemplary flow of operations 200B of a second machine learning application, in accordance with some implementations. The flow of operations 200B includes a combination of elements 210B, 212B, 220B, 230B, 250B, and 260B, where each element represents operations that would be performed in response to a request for the second machine learning application. A first element 210B represents a preprocessing operation. The preprocessing operation 210B receives data related to the request as input (e.g., first data), performs one or more operations on the data, and outputs processed data. In some implementations, preprocessing the data includes preparing the data for the third scoring service 220B. For example, the preprocessing can include extracting from the data related to the request features that can be used in a machine learning model of the third scoring service 220B to obtain a first scoring result. Additionally or alternatively, the processing can include retrieving from one or more data stores (e.g., tenant database) the features to be used in the machine learning model based on data included in the request. Element 212B represents another preprocessing operation. The preprocessing operation 212B receives data related to the request as input (e.g., second data, the second data can be the same as or different from the first data fed to preprocessing 210B), performs one or more operations on the data, and outputs processed data. In some implementations, preprocessing the data includes preparing the data for the fourth scoring service 230B. For example, the preprocessing can include extracting from the data related to the request features that can be used in a machine learning model of the fourth scoring service 230B to obtain a second scoring result. Additionally or alternatively, the processing can include retrieving from one or more data stores (e.g., tenant database) the features to be used in the machine learning model based on data included in the request. The flow of operations includes a combiner 250B, which is operative to receive the first scoring result and the second scoring result and outputs a combination of these results. In some implementations, the combination can be an aggregation of the results as a list of results. In other implementations, the combination can perform an operation on the scoring results to obtain a single combined scoring result (e.g., addition, subtraction, averaging, etc.). The element 240A represents a postprocessing operation. The post processing operation 240A receives data from the combined 250B, performs one or more operations on the data, and outputs a scoring result that is to be returned to the tenant application in response to the request. The flow of operations 200B presents an example of machine learning applications where two scoring services are used in parallel. The outputs of the first scoring service and the second scoring service are combined to determine a scoring result for the machine learning applications. While the exemplary flow 200B includes two scoring services, in other examples, additional scoring services and/or operations can be included. While FIGS. 2A-B present two examples of flows of operations that define two distinct machine learning applications, these flows of operations are presented as exemplary flows and other combinations of scoring services and/or operations can be used for defining a machine learning application based on the use case.

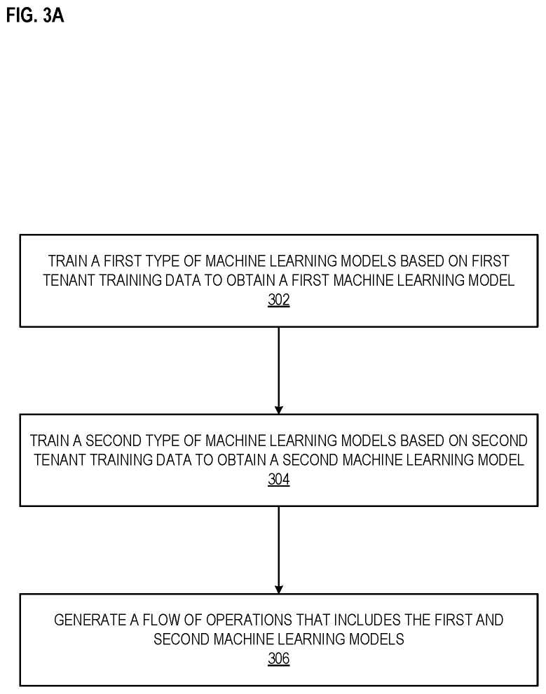

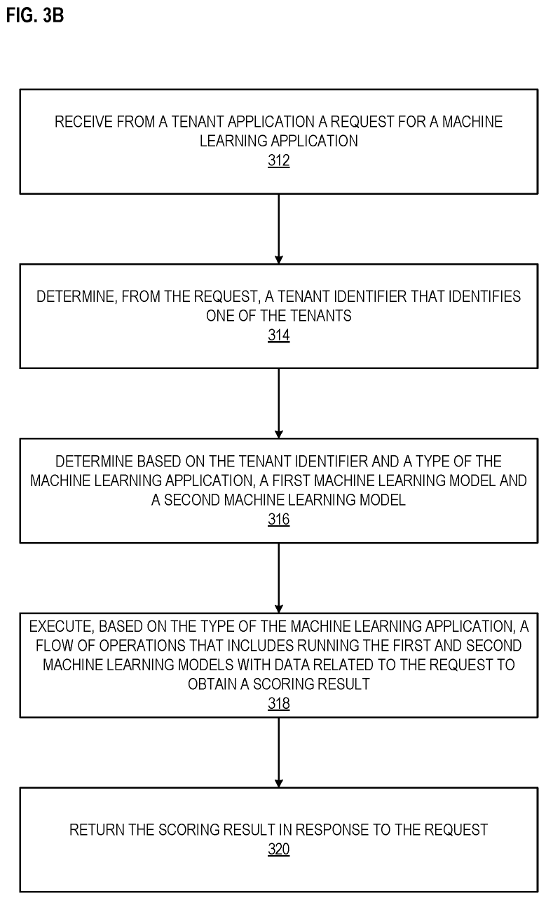

FIG. 3A illustrates a flow diagram of exemplary operations that can be performed in an MLS infrastructure, in accordance with some implementations. The MLS infrastructure can support one or multiple types of machine learning models. Each type of machine learning model can be trained based on tenant data to obtain a machine learning model. The machine learning model is used for responding to requests to a scoring service and to obtain predictions or scoring results. During a training phase, the machine learning models are generated using tenant data.

At operation 302, the MLS infrastructure 100 trains a first type of machine learning models based on first tenant training data to obtain a first machine learning model. The first machine learning model is associated with a unique identifier. At operation 304, the MLS infrastructure 100 trains a second type of machine learning models based on second tenant training data to obtain a second machine learning model. In some implementations, the first type of machine learning model is different from the second type of machine learning model. In some implementations, the first type of machine learning model can be the same as the first type of machine learning but trained with different sets of training data resulting in two different machine learning models. The second machine learning model is associated with a unique identifier. The first machine learning model and the second machine learning model are for the same tenant. In some implementations, the MLS infrastructure 100 may support more than two machine learning models for a single tenant. Each of the machine learning models is associated with a unique identifier. The machine learning models are stored in a data storage 170. The machine learning models can be retrieved based on an identifier.

At operation 306, a flow of operations that includes the first and second machine learning models is created. The flow of operations can include additional elements for processing data received in a tenant request prior to using the data in one of the machine learning models, for processing the scoring results, and/or combining the scoring results. In some implementations, the flow of operations is associated with an identifier that is associated with the identifiers of the machine learning models. The flow of operations can be referred to as a pipeline. The flow of operations is executable. In some implementations, the flow of operations can be deployed through an API call (e.g., an HTTP POST request) that makes the flow of operations visible to a provisioning process. The provisioning process executes the flow of operations. In some implementations, the flow of operations is provisioned/executed in a containerized environment.

FIG. 3B illustrates a flow of exemplary operations for responding to a request of a machine learning application, in accordance with some implementations.

At operation 312, the router 130 receives from a tenant application a request of a machine learning application. The request can include an application type that identifies the type of machine learning applications and a tenant identifier. In some implementations, the request further includes a version of the machine learning application when the machine learning application has several versions. The request can be a call to the machine learning application presented as an HTTP request, such as:
POST/ApplicationType/predictions HTTP/1.1
tenant-identifier: tenant_id
Body

At operation 314, the router 130 determines the tenant identifier that identifies the tenant from multiple tenant supported by the MLS infrastructure 100. The tenant identifier is obtained by parsing the request.

At operation 316, the router 130 determines, based on the tenant identifier and the type of the machine learning application, a first machine learning model that was generated based on a first training data set associated with the tenant identifier and a second machine learning model that was generated based on a second training data set associated with the tenant identifier. In some implementations, the router determines the first and second machine learning models by sending a request to the version management component 140. For example, the router 130 can send an HTTP Get request, such as:
GET—versionmanagement/v1.0/Models?applicationType=“First_Type”&tenant=“tenant_id.”

The router 130 receives a response to the request, where the response includes identifiers of the first machine learning model and the second machine learning models respectively. In some implementations, the router 130 receives a response that includes an identifier of the flow of operations that is defined for the machine learning application and the tenant. The identifier of the flow of operations (e.g., a pipeline ID) is then used to retrieve the identifiers of the models that are part of the flow of operations, e.g., first and second models. For example, the router may send a request to the version management component 140 that includes the identifier of the flow of operations and receive a list of service and/or function identifiers that need to be executed to respond to the request.

At operation 318, the router 130 executes, based on the type of the machine learning application, a flow of operations that includes running the first and second machine learning models with data related to the request to obtain a scoring result. In one implementation, executing the flow of operations includes transmitting a first request to a first scoring service to run the first machine learning model with data related to the request to obtain a first scoring result, receiving the first scoring result from the first scoring service, and transmitting a second request to a second scoring service to run the second machine learning model with at least the first scoring result to obtain the scoring result. For example, when the flow of operations is the flow 200A, the router 130 sends independent requests to the first and second scoring services, which respectively use the first and second machine learning models, in sequence. In this example, the router 130 sends a request to the first scoring service to obtain the first scoring result and sends another request to the second scoring service when the first scoring result is received. The request to the second scoring service includes data from the first scoring result to be used in the second model. In another implementation, the router executes the flow of operations 200B by transmitting a request to the first scoring service to run the first machine learning model with the first data to obtain the first scoring result, and transmits a second request to the second scoring service to run the second machine learning model with the second data to obtain a second scoring result independently of the first scoring result. The router 130 receives the first and the second scoring results from the first and second scoring services respectively and combines the first and the second scoring results to obtain the scoring result. In some implementations, the router 130 combines the first and the second scoring results by aggregating the first and second scoring results. In other implementations, the router 130 combines the first and second scoring results by presenting the independent results in a list or set.

In some implementations, when a request is sent to a scoring service, the scoring service running in a container determines whether the machine learning model is deployed. In response to determining that the machine learning model is not deployed; the scoring service retrieves the machine learning model from a machine learning model datastore based on the identifier of the model. In response to determining that the machine learning model is deployed, the scoring service runs the model on the data received in the request to obtain the prediction (scoring result). The scoring service returns the scoring result to the router 130.

In some implementations, when the flow of operations includes one or more additional operations that do not include the execution of a machine learning model (e.g., pre-processing, post-processing, combiner, etc.), the router 130 can execute these operations locally as part of the same process or use the remote call procedure (similar to the one used for calling scoring services) to call one or more other remote services executed in the cluster of containers 160A-N. When the router 130 calls remote service, these services can be identified based on the tenant identifier and the type of applications. The identification of the services can be performed by sending a request to the version management component 140 and receiving the identifiers of these services. Based on the identifiers the router can generate sub-requests to send to each of the services as well as the order of execution of the multiple services.

At operation 320, the router returns the scoring result in response to the request from the tenant application. The scoring result includes predicted information for the record according to the first and second machine learning models. In some implementations, the scoring result can include predicted information from multiple machine learning models.

The implementations described above present a central element of the MLS infrastructure, the router 130, that is operative to handle coordination of multiple operations of a machine learning applications in low latency. The router 130 allows the sub-elements of the flow of operations (e.g., a pre-processing, first model, second model, post-processing) to be responsible for their execution without the need for supporting coordination with the other sub-elements of the flow. The router 130 is a layer of the MLS infrastructure 100 that is responsible for the flow execution, failure handling, caching, parallelization, load distribution, and determination of the tenant specific models and contexts that need to be retrieved for responding to a request from a tenant application. In the implementations described above, the router 130 enables the execution of the flow of operations of an application based on the type of the application and the tenant identifier, is somewhat responsible for these features per App Type.

Machine Learning Applications Based on Directed Acyclic Graphs

In some implementations, the flow of operations of a machine learning application is hardcoded in the router 130. In these implementations for a given type of machine learning application (e.g., 200A or 200B), the router 130 identifies the type and the tenant that submits the request and executes the operations of the flow that is implemented as part of the router itself. This tight coupling between the flow of operations and the router requires developers to spend an excessive amount of time for the definition and onboarding of new ML applications. Further, it forces the developer teams to bundle all the scoring services under a single prediction API to allow the multiple elements of the pipeline to adequately communicate. These implementations do not allow for partial retries and potential parallelization at finer grains (e.g., at the sub-element level of the flow of operations).

The implementations described herein provide a flexible and dynamic structure for defining a machine learning application based on a directed acyclic graph structure. The implementations herein enable a modular and easy machine learning flow definition mechanism. In some implementations, developers can use a DSL to define the machine learning application. In other implementations, developers can use human readable language (such as YAML or JSON) to define the machine learning application.

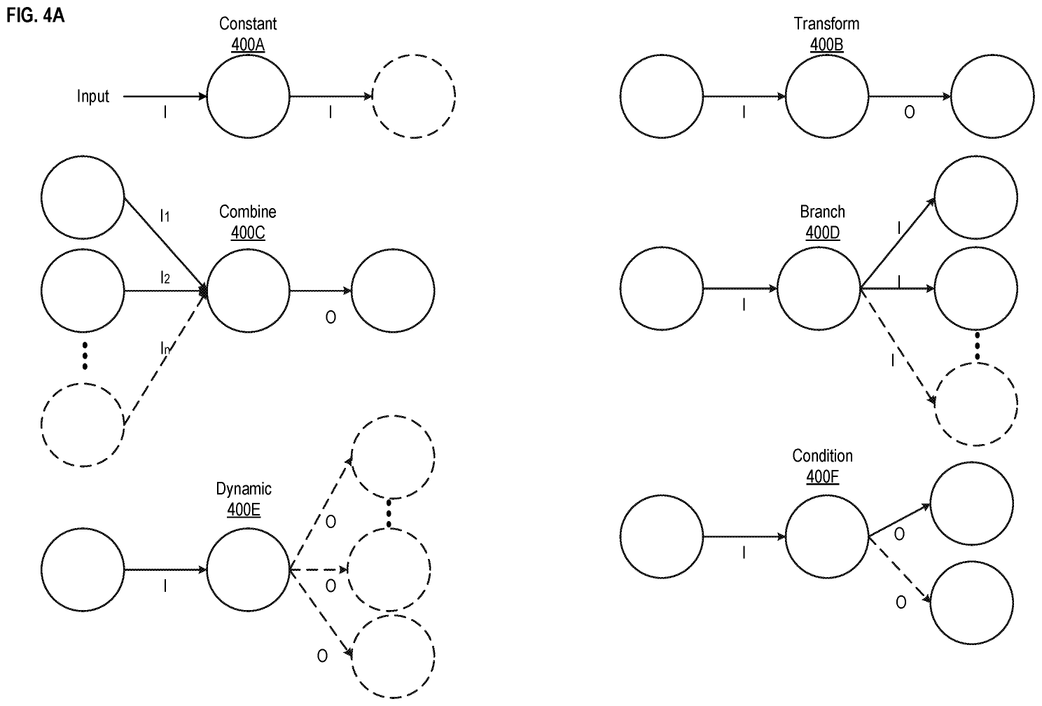

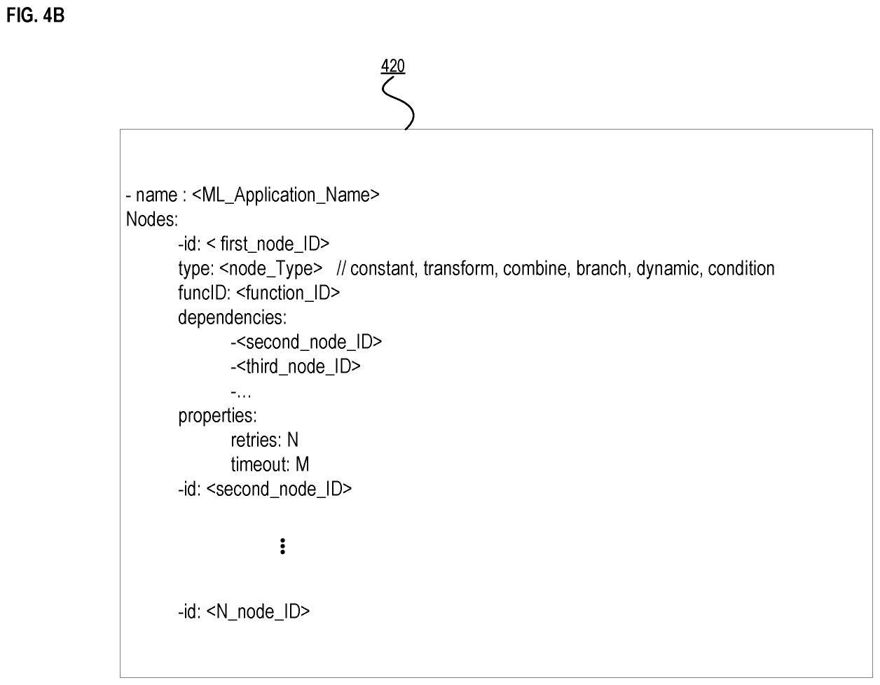

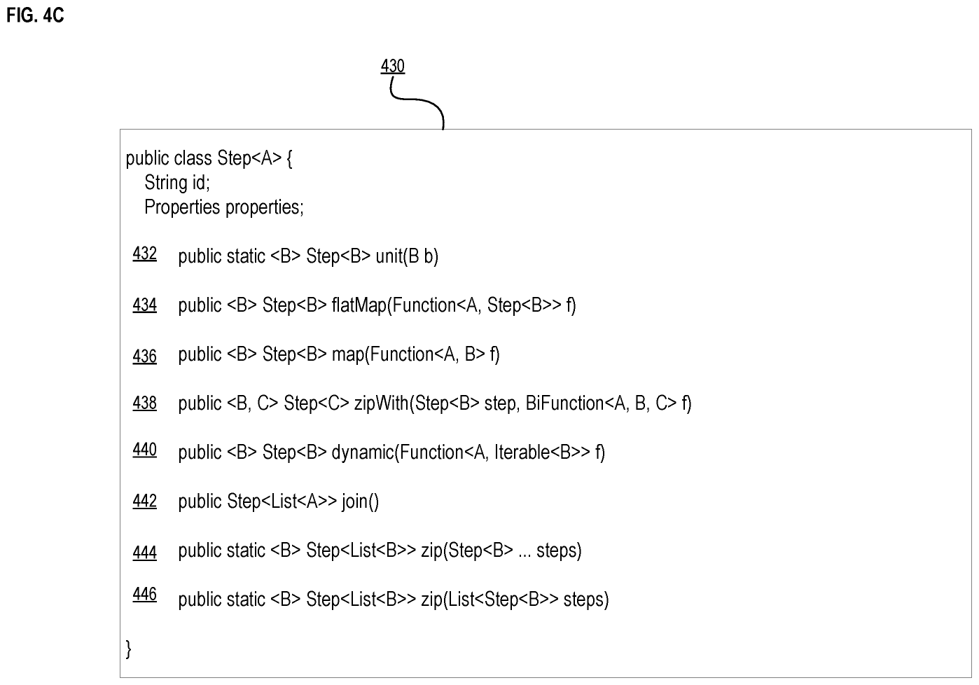

FIG. 4A illustrates a block diagram of nodes that can be used in a DAG for defining a machine learning application, in accordance with some implementations. A DAG may include a node 400A of type Constant, a node 400B of type transform, a node 400C of type combine, a node 400D of type branch, a node 400E of type dynamic, a node 400F of type condition.

A constant node 400A represents the request received from a tenant application. The constant node takes the request as input and outputs the next node that is to be performed in the graph. A transform node 400B is coupled with a first node and a second node. The transform node 400B receives an input from the first node, transforms the data according to a function that is defined for the node, and outputs the transformed data to the second node. A combine node 400C is coupled with two or more nodes from which inputs are received and combines these inputs according to a function defined for the node, to obtain an output that is fed to an output node. A branch node 400D receives an input from a first node and sends this input to two or more nodes for further processing, where each of the nodes can perform an operation, which can be the same or different from the operation performed in another one of the output nodes. A dynamic node 400E receives an input from a first node and based on this input determines whether to branch to one or multiple ones of a potential set of nodes. Dynamic node 400E allows for a dynamic branching that depends on the input. In contrast to a branch node which always branches out to the same number of nodes regardless of the input received, the dynamic node allows for a varying number of nodes depending on the input. For example, in a non-limiting example for a request received for a given tenant and user of the tenant, the dynamic node can branch out to two output nodes, while for a request for the same tenant but a different user of the tenant, the dynamic node can branch out to three output nodes. A condition node 400F receives an input from a node and based on the input branches out to only one of two or more nodes.

Some implementations provide a human readable data serialization language such as the one illustrated in FIG. 4B for enabling a developer/data scientist to define a machine learning application for a tenant of the MLS infrastructure. FIG. 4B illustrates a block diagram of an exemplary data serialization language that can be used for creating a graph structure that represents a machine learning application, in accordance with some implementations. For example, the language 420 can be used to define the ML applications 200A or 200B. The data serialization language 420 includes a name field that includes a name of the machine learning application. The data serialization language 420 includes a Nodes field that includes a list of two or more nodes that define the sub-elements of the flow of operations of the ML application. For each of the nodes, there is a node identifier and a type of the node, where the type of the node can be one of constant, transform, combine, branch, dynamic, or condition. Further, the node includes the dependencies (one or more nodes) which are identified by their respective identifiers. The node can optionally include an identifier of a function that is to be applied on data. Depending on the type of the node, the function may not be included. For example, a node of type constant does not include a function. The node may further include additional optional properties such as a number of retries and a period of timeout. The number of retries can be set by a developer to indicate how many times the node can be repeated if its execution fails. The timeout period indicates an interval of time after which a node is to stop execution even if execution is not complete. The definition 420 includes the multiple nodes of the graph.

Some implementations provide a domain specific language (DSL) such as the one illustrated in FIG. 4C for enabling a developer/data scientist to define a machine learning application for a tenant of the MLS infrastructure. The DSL provides methods that can be used for implementing the multiple node types of a DAG. The DSL 430 will be described with reference to the variables A, B, C, which can be of any type. For example, the DSL 240 has a unit method 432 that takes a variable b of type B, as input and returns a node of the graph. A Step in the DSL represents a node of the graph and can include operations to be performed on data input to the node. The operations can include a remote call to a service, such as a scoring service. To implement a node of type transform, a developer may use the map method 436. The map method 436 applies a function f to the input of type A to obtain an output of type B. To implement a node of type combine, a developer can use the zipWith method 438, which applies the function f into an input of type A and input of type B to obtain an output of type C. While the zipWith method is illustrated with a function f that is applied on two inputs, the zipWith method can use any function that is applied to two or more inputs. In some implementations, an exemplary use of zipWith can be performed according to the following syntax: step1.zipWith(step2, f) to combine A with B according to f and obtain C, where A is from step1 node and B is from step2 node. In another example, to implement a node of type combine a developer can use the Zip method 444 or 446. To implement a branching node, a developer can apply a method to multiple entries. For example, when the branching node includes the application of different functions (e.g., f1, f2, f3) to the same input, a developer may use the following syntax: step.map(f1), step.map(f2), and step.map(f3). To implement a dynamic node, a dynamic method 440 is used. The dynamic method 440 applies a function f on an input A to obtain a list of nodes. For example, the dynamic method 440 can be applied on data from the request received for the machine learning application to obtain a list of one or more machine learning models that need to be used on the data to obtain one or more predictions. The list of the models depends on the data input to the dynamic method. Once the list of nodes is obtained a join method 442 is performed to merge the results of the dynamic function into a list of values. A developer can use the following syntax to implement a dynamic node step.dynamic(f).join( ). To implement a node of type condition, the developer can use a flatmap method 434, which applies a function f to an input of type A to obtain a step B (i.e., another node). The DSL code provides flexibility to a developer for easily defining the machine learning application. Further, using a code-based definition allows to ensure type safety between the nodes, as any type errors can be detected during compilation of the code.

A developer/data scientist can use the language and/or the DSL code of FIGS. 4B-C to define a custom machine learning application that is applicable to one or more tenants. In the serialization language case, the developer defines two or more nodes and connects them. For each node, a data scientist assigns an identifier to the node, a type of the node, and optionally a function for the node. The developer can identify the dependencies of the node and one or more optional properties (e.g., retries or timeouts). In one implementation, the function selected for a node of the definition 420 can be tenant specific. In other implementations, the function selected for a node can be a generic function that is applicable to all tenants.

A graph structure defining an ML application can include only tenant specific functions, a mix of tenant specific and generic functions, or only generic functions that are applicable to all tenants. In some implementations, the function identifier in a node can identify a scoring service (which is accessed through a remote call such as webservice request, or an API call). The scoring service is not associated with a tenant when the machine learning application is defined and becomes associated with a tenant at run time when a request for the machine learning application is processed for a tenant. In some implementations, the MLS infrastructure can include a registry of functions (e.g., which can be populated by developers, data scientists), where each function is identified with a function identifier. The function identifier can be used to retrieve the function at run time when the machine learning application is executed for responding to a request. In some implementations, a function can be stored in a function registry based on a type of the function and an identifier of a tenant. For example, a function can include a scoring service that calls a type of machine learning models for predicting an outcome. The function is associated with the type of scoring service and the tenant ID. The tenant ID and the type of scoring service can be used to retrieve an identifier of a model that is generated based on tenant data corresponding to that tenant ID.

When a developer defines the machine learning application using DSL code, the MLS infrastructure compiles the code to obtain an executable version of the machine learning application, which is used to respond to an on-demand request for the machine learning application. When a developer defines the machine learning application using data serialization language, the MLS infrastructure compiles data serialization language file into code, which is interpreted to obtain an executable version of the machine learning application. The executable is then used to respond to an on-demand request for the machine learning application. In some implementations, the executable machine learning application that is defined based on a graph structure is associated with an identifier.

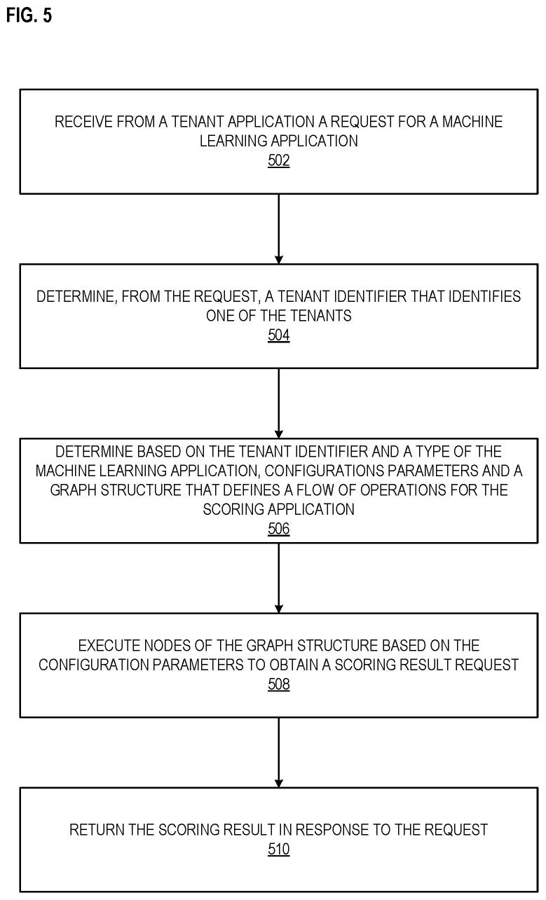

FIG. 5 illustrates a flow diagram of exemplary operations that can be performed for responding to an on-demand request for a machine learning application when the application is defined according to a graph structure, in accordance with some implementations.

At operation 502, the router 130 receives from a tenant application a request of a machine learning application. The request can include an application type that identifies the type of machine learning applications and a tenant identifier. In some implementations, the request further includes a version of the machine learning application when the machine learning application has several versions. The request can be a call to the machine learning application presented as an HTTP request as described above.

At operation 504, the router 130 determines the tenant identifier that identifies the tenant from multiple tenants that are served by the MLS infrastructure 100. The tenant identifier is obtained by parsing the request.

At operation 506, the router 130 determines, based on the tenant identifier and the type of the machine learning application, configuration parameters and a graph structure that defines a flow of operations for the machine learning application. In some implementations, determining the graph structure includes determining an identifier of the graph structure and retrieving the graph structure based on the identifier. The identifier of the graph structure can be determined based on the type of the machine learning application and the tenant identifier. In some implementations, the identifier of the graph structure can be determined based on the type of the machine learning application only. For example, the identifier of the tenant and the type of machine learning application can be used as indices in a data structure to retrieve the identifier of the graph. In some implementations, a tenant identifier can be associated with multiple graph structures indicating that multiple machine learning applications are available for this tenant. In some implementations, the configuration parameters can include tenant specific context (e.g., records, and/or history) that can be used when executing the nodes of the graph structure for responding to the request. In some implementations, the configuration parameters can further include tenant specific functions and/or models to be used during execution of the graph structure. In some implementations, the configuration parameters can be determined based on the tenant identifier and the type of machine learning application. In some implementations, the configuration parameters can be determined based on the identifier of the graph structure.

At operation 508, the router 130 executes nodes of the graph structure based on the configuration parameters to obtain a scoring result. The execution of the nodes includes executing a first node, based on the first configuration parameters, that causes a first machine learning model generated for the tenant to be applied to data related to the request. In some implementations, executing the first node includes transmitting a scoring request for a scoring service to apply the first machine learning model to the data related to the first request and obtain a scoring result; and receiving the scoring result in response to the scoring request. In some implementations, the scoring result can be output as a response to the request for the machine learning application. In other implementations, the scoring result can be fed to another node of the graph structure for further processing. The additional processing in the subsequent node can include another call to another scoring service and/or function defined in the graph structure. The execution of the nodes continues until the end of the graph structure is reached. In some implementations, the execution of a node can be repeated and/or stopped according to the properties of the nodes (e.g., retries or timeout). In some implementations, when the number of retries is reached for the node without success of execution of the node a failure message can be returned instead of the response to the request for the machine learning application.

In some implementations, the nodes of the first graph structure include a dynamic node, which when executed, based on an input associated with the request, dynamically branches out into one or more nodes from a plurality of possible nodes for the dynamic node. The one or more nodes represent operations of the first machine learning application that are unknown before execution of the dynamic node based on the input. In one non-limiting example, a node of type dynamic can be associated with N potential nodes, where each one includes a different operation that is to be performed on the data. In one example, at least two of these nodes can include remote calls to scoring services.

In some implementations, the nodes of the first graph structure include a node that causes the router to execute one or more operations as part of the same process that handles the management of the calls to remote services. In these implementations, there no need for containerization of these operations. The router 130 is operative to execute operations of a node within the same process as the one handling the management of the execution of the remote service calls (e.g., remote call to a scoring service) and coordinate inputs and outputs between the nodes for execution of the flow of operations of the machine learning application.

In some implementations, the MLS infrastructure 100 receives another request for the machine learning application. The other request can be from another tenant that is different from the first tenant. However, the request can be for the same machine learning application. In this case the router 130 determines, from the second request, the second tenant identifier that identifies the second tenant. The router 130 determines, based on the second tenant identifier and the type of the machine learning application, second configuration parameters and the same graph structure as the one determined for the first tenant. The router 130 executes the nodes of the first graph structure based on the second configuration parameters to obtain a second scoring result. The execution of the first graph structure with the second configuration parameters includes executing the first node based on the second configuration parameters that causes a second machine learning model generated for the second tenant to be applied to data related to the second request. Thus, the implementations herein allow the use of the same graph structure for two different tenants, while enabling the selection and use of tenant specific models for responding to scoring requests. For example, executing the first node includes transmitting a scoring request for the scoring service to apply the second machine learning model to the data related to the second request and obtain the second scoring result; and receiving the second scoring result in response to the scoring request. The second machine learning model is generated based on tenant data associated with the second tenant and is different from the first machine learning model used for the first tenant. As described above, the result from the application of the second machine learning model can be output in response to the request for the machine learning application or fed to another node of the graph structure, depending on the flow of operations of the structure.

In some implementations, the MLS infrastructure 100 can receive a third request for a second machine learning application. The third request can be from a tenant that was previously served according to another machine learning application. In this case the router 130 determines, from the third request, the tenant identifier that identifies the first tenant. The router 130 determines, based on the tenant identifier and the type of the second machine learning application, configuration parameters and a different graph structure as the one previously determined for the first tenant. The router 130 executes the nodes of the second graph structure based on the configuration parameters to obtain a scoring result. The execution of the second graph structure with the configuration parameters includes executing a node that causes another machine learning model generated for the first tenant to be applied to data related to this request. Thus, the implementations herein allow the use of different graph structures for two different applications for a same tenant.

At operation 510, the scoring result obtained from execution of the graph structure based on the configuration parameters is returned to the tenant application in response to the request for the machine learning application.

The implementations described herein present a flexible mechanism for defining the flow of operations of a machine learning application. A data scientist may generate a flow of operations by defining a graph structure including nodes, where at least one node of the graph includes a scoring service based on a prediction model. In some implementations, the graph structure may include two or more nodes that apply machine learning models. In some implementations, the graph structure includes nodes with operations that can be performed locally as part of the same process that handles execution and management of the machine learning models. In some implementations, the graph structure includes a dynamic node. The dynamic node when executed, based on an input associated with the request for the machine learning application, dynamically branches out into one or more nodes from a plurality of possible nodes for the dynamic node. The nodes to which the dynamic nodes branches out are unknown before execution of the dynamic node based on the input.

Example Electronic Devices and Environments

Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

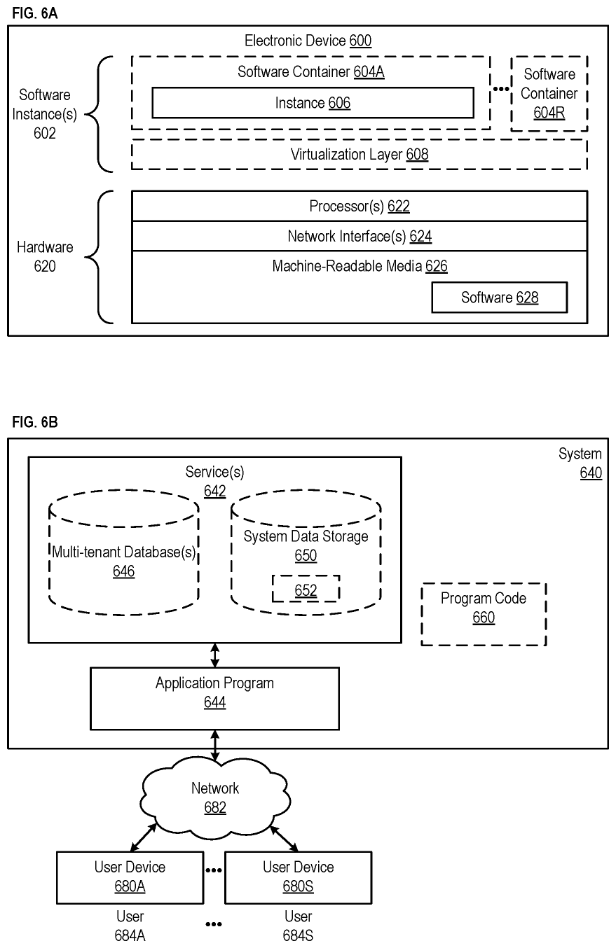

FIG. 6A is a block diagram illustrating an electronic device 600 according to some example implementations. FIG. 6A includes hardware 620 comprising a set of one or more processor(s) 622, a set of one or more network interfaces 624 (wireless and/or wired), and machine-readable media 626 having stored therein software 628 (which includes instructions executable by the set of one or more processor(s) 622). The machine-readable media 326 may include non-transitory and/or transitory machine-readable media. Each of the previously described tenant applications and the MLS infrastructure may be implemented in one or more electronic devices 600. In one implementation: 1) each of the tenant applications is implemented in a separate one of the electronic devices 600 (e.g., in end user devices where the software 628 represents the software to implement clients to interface directly and/or indirectly with the MLS infrastructure (e.g., software 628 represents a web browser, a native client, a portal, a command-line interface, and/or an application programming interface (API) based upon protocols such as Simple Object Access Protocol (SOAP), Representational State Transfer (REST), etc.)); 2) the MLS infrastructure is implemented in a separate set of one or more of the electronic devices 600 (e.g., a set of one or more server devices where the software 628 represents the software to implement the MLS infrastructure); and 3) in operation, the electronic devices implementing the tenant applications and the MLS infrastructure would be communicatively coupled (e.g., by a network) and would establish between them (or through one or more other layers and/or or other services) connections for submitting a request to the MLS infrastructure and returning scoring result(s) to the tenant applications. Other configurations of electronic devices may be used in other implementations (e.g., an implementation in which the tenant applications and the MLS infrastructure are implemented on a single one of electronic device 600).

During operation, an instance of the software 628 (illustrated as instance 606 and referred to as a software instance; and in the more specific case of an application, as an application instance) is executed. In electronic devices that use compute virtualization, the set of one or more processor(s) 622 typically execute software to instantiate a virtualization layer 608 and one or more software container(s) 604A-304R (e.g., with operating system-level virtualization, the virtualization layer 608 may represent a container engine (such as Docker Engine by Docker, Inc. or rkt in Container Linux by Red Hat, Inc.) running on top of (or integrated into) an operating system, and it allows for the creation of multiple software containers 604A-304R (representing separate user space instances and also called virtualization engines, virtual private servers, or jails) that may each be used to execute a set of one or more applications; with full virtualization, the virtualization layer 608 represents a hypervisor (sometimes referred to as a virtual machine monitor (VMM)) or a hypervisor executing on top of a host operating system, and the software containers 604A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 628 is executed within the software container 604A on the virtualization layer 608. In electronic devices where compute virtualization is not used, the instance 606 on top of a host operating system is executed on the “bare metal” electronic device 600. The instantiation of the instance 606, as well as the virtualization layer 608 and software containers 604A-304R if implemented, are collectively referred to as software instance(s) 602.

Alternative implementations of an electronic device may have numerous variations from that described above. For example, customized hardware and/or accelerators might also be used in an electronic device.

Example Environment

FIG. 6B is a block diagram of a deployment environment according to some example implementations. A system 640 includes hardware (e.g., a set of one or more server devices) and software to provide service(s) 642, including the XYZ service. In some implementations, the system 640 is in one or more datacenter(s). These datacenter(s) may be: 1) first party datacenter(s), which are datacenter(s) owned and/or operated by the same entity that provides and/or operates some or all of the software that provides the service(s) 642; and/or 2) third-party datacenter(s), which are datacenter(s) owned and/or operated by one or more different entities than the entity that provides the service(s) 642 (e.g., the different entities may host some or all of the software provided and/or operated by the entity that provides the service(s) 642). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 640 is coupled to user devices 680A-380S over a network 682. The service(s) 642 may be on-demand services that are made available to one or more of the users 684A-384S working for one or more entities other than the entity which owns and/or operates the on-demand services (those users sometimes referred to as outside users) so that those entities need not be concerned with building and/or maintaining a system, but instead may make use of the service(s) 642 when needed (e.g., when needed by the users 684A-384S). The service(s) 642 may communicate with each other and/or with one or more of the user devices 680A-380S via one or more APIs (e.g., a REST API). In some implementations, the user devices 680A-380S are operated by users 684A-384S, and each may be operated as a client device and/or a server device. In some implementations, one or more of the user devices 680A-380S are separate ones of the electronic device 600 or include one or more features of the electronic device 600.

In some implementations, the system 640 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 640 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 640 may include an application platform 644 that enables PAAS for creating, managing, and executing one or more applications developed by the provider of the application platform 644, users accessing the system 640 via one or more of user devices 680A-380S, or third-party application developers accessing the system 640 via one or more of user devices 680A-380S.

In some implementations, one or more of the service(s) 642 may use one or more multi-tenant databases 646, as well as system data storage 650 for system data 652 accessible to system 640. In certain implementations, the system 640 includes a set of one or more servers that are running on server electronic devices and that are configured to handle requests for any authorized user associated with any tenant (there is no server affinity for a user and/or tenant to a specific server). The user devices 680A-380S communicate with the server(s) of system 640 to request and update tenant-level data and system-level data hosted by system 640, and in response the system 640 (e.g., one or more servers in system 640) automatically may generate one or more Structured Query Language (SQL) statements (e.g., one or more SQL queries) that are designed to access the desired information from the multi-tenant database(s) 646 and/or system data storage 650.

In some implementations, the service(s) 642 are implemented using virtual applications dynamically created at run time responsive to queries from the user devices 680A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 660 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 644 includes an application setup mechanism that supports application developers' creation and management of applications, which may be saved as metadata by save routines. Invocations to such applications, including the MLS infrastructure, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 682 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 640 and the user devices 680A-380S.

Each user device 680A-380S (such as a desktop personal computer, workstation, laptop, Personal Digital Assistant (PDA), smart phone, augmented reality (AR) devices, virtual reality (VR) devices, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 640. For example, the user interface device can be used to access data and applications hosted by system 640, and to perform searches on stored data, and otherwise allow one or more of users 684A-384S to interact with various GUI pages that may be presented to the one or more of users 684A-384S. User devices 680A-380S might communicate with system 640 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 680A-380S might include an HTTP client, commonly referred to as a “browser,” for sending and receiving HTTP messages to and from server(s) of system 640, thus allowing users 684A-384S of the user devices 680A-380S to access, process and view information, pages and applications available to it from system 640 over network 682.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A method in a machine learning serving infrastructure that serves a plurality of tenants, the method comprising:
receiving from a first tenant application a first request for a first machine learning application;
determining, from the first request, a first tenant identifier that identifies a first of the plurality of tenants;
determining, based on the first tenant identifier and a first type of the first machine learning application, first configuration parameters and a first graph structure that defines a flow of operations for the first machine learning application;
executing nodes of the first graph structure based on the first configuration parameters to obtain a first scoring result, wherein the executing includes executing a first of the nodes, based on the first configuration parameters, that causes a first machine learning model generated for the first tenant to be applied to data related to the first request; and
returning the first scoring result in response to the first request.

2. The method of claim 1 further comprising:
receiving from a second tenant application a second request of the first machine learning application;
determining, from the second request, a second tenant identifier that identifies a second of the plurality of tenants that is different from the first tenant;
determining, based on the second tenant identifier and the first type of the first machine learning application, second configuration parameters and the first graph structure;
executing the nodes of the first graph structure based on the second configuration parameters to obtain a second scoring result, wherein the executing includes executing the first of the nodes based on the second configuration parameters that causes a second machine learning model generated for the second tenant to be applied to data related to the second request; and
returning the second scoring result in response to the second request.

3. The method of claim 1 further comprising:
receiving from a third tenant application a third request for a second machine learning application that is different from the first machine learning application;
determining, from the third request, the first tenant identifier that identifies the first of the plurality of tenants;
determining, based on the first tenant identifier and a second type of the second machine learning application, third configuration parameters and a second graph structure;
executing nodes of the second graph structure based on the third configuration parameters to obtain a third scoring result, wherein the executing includes executing a first of the nodes of the second graph structure based on the third configuration parameters that causes a third machine learning model generated for the first tenant to be applied to data related to the third request; and
returning the third scoring result in response to the third request.

4. The method of claim 1, wherein the executing the first of the nodes, based on the first configuration parameters, includes:
transmitting a scoring request for a scoring service to apply the first machine learning model to the data related to the first request and obtain a fourth scoring result; and
receiving the fourth scoring result in response to the scoring request.

5. The method of claim 1, wherein the nodes of the first graph structure include a dynamic node, which when executed, based on an input associated with the first request, dynamically branches out into one or more nodes from a plurality of possible nodes for the dynamic node, wherein the one or more nodes are operations of the first machine learning application that are unknown before execution of the dynamic node based on the input.

6. The method of claim 1, wherein the first tenant application is a customer relationship management (CRM) application and the data related to the first request includes one or more fields of a record that is identified in the first request.

7. The method of claim 6, wherein the first scoring result is based at least in part on fourth scoring results obtained from applying the first machine learning model to the data related to the first request.

8. A non-transitory machine-readable storage medium that provides instructions that, if executed by a set of one or more processors of a machine learning serving infrastructure that serves a plurality of tenants, are configurable to cause said set of one or more processors to perform operations comprising:
receiving from a first tenant application a first request for a first machine learning application;
determining, from the first request, a first tenant identifier that identifies a first of the plurality of tenants;
determining, based on the first tenant identifier and a first type of the first machine learning application, first configuration parameters and a first graph structure that defines a flow of operations for the first machine learning application;
executing nodes of the first graph structure based on the first configuration parameters to obtain a first scoring result, wherein the executing includes executing a first of the nodes, based on the first configuration parameters, that causes a first machine learning model generated for the first tenant to be applied to data related to the first request; and
returning the first scoring result in response to the first request.

9. The non-transitory machine-readable storage medium of claim 8, wherein the operations further comprise:
receiving from a second tenant application a second request of the first machine learning application;
determining, from the second request, a second tenant identifier that identifies a second of the plurality of tenants that is different from the first tenant;
determining, based on the second tenant identifier and the first type of the first machine learning application, second configuration parameters and the first graph structure;
executing the nodes of the first graph structure based on the second configuration parameters to obtain a second scoring result, wherein the executing includes executing the first of the nodes based on the second configuration parameters that causes a second machine learning model generated for the second tenant to be applied to data related to the second request; and
returning the second scoring result in response to the second request.

10. The non-transitory machine-readable storage medium of claim 8, wherein the operations further comprise:
receiving from a third tenant application a third request for a second machine learning application that is different from the first machine learning application;
determining, from the third request, the first tenant identifier that identifies the first of the plurality of tenants;
determining, based on the first tenant identifier and a second type of the second machine learning application, third configuration parameters and a second graph structure;
executing nodes of the second graph structure based on the third configuration parameters to obtain a third scoring result, wherein the executing includes executing a first of the nodes of the second graph structure based on the third configuration parameters that causes a third machine learning model generated for the first tenant to be applied to data related to the third request; and
returning the third scoring result in response to the third request.

11. The non-transitory machine-readable storage medium of claim 8, wherein the executing the first of the nodes, based on the first configuration parameters, includes:
transmitting a scoring request for a scoring service to apply the first machine learning model to the data related to the first request and obtain a fourth scoring result; and
receiving the fourth scoring result in response to the scoring request.

12. The non-transitory machine-readable storage medium of claim 8, wherein the nodes of the first graph structure include a dynamic node, which when executed, based on an input associated with the first request, dynamically branches out into one or more nodes from a plurality of possible nodes for the dynamic node, wherein the one or more nodes are operations of the first machine learning application that are unknown before execution of the dynamic node based on the input.

13. The non-transitory machine-readable storage medium of claim 8, wherein the first tenant application is a customer relationship management (CRM) application and the data related to the first request includes one or more fields of a record that is identified in the first request.

14. The non-transitory machine-readable storage medium of claim 13, wherein the first scoring result is based at least in part on fourth scoring results obtained from applying the first machine learning model to the data related to the first request.

15. An apparatus of a machine learning serving infrastructure that serves a plurality of tenants comprising:
a set of one or more processors; and
a non-transitory machine-readable storage medium that provides instructions that, if executed by the set of one or more processors, are configurable to cause the apparatus to perform operations comprising,
receiving from a first tenant application a first request for a first machine learning application,
determining, from the first request, a first tenant identifier that identifies a first of the plurality of tenants,
determining, based on the first tenant identifier and a first type of the first machine learning application, first configuration parameters and a first graph structure that defines a flow of operations for the first machine learning application,
executing nodes of the first graph structure based on the first configuration parameters to obtain a first scoring result, wherein the executing includes executing a first of the nodes, based on the first configuration parameters, that causes a first machine learning model generated for the first tenant to be applied to data related to the first request, and
returning the first scoring result in response to the first request.

16. The apparatus of claim 15, wherein the operations further comprise:
receiving from a second tenant application a second request of the first machine learning application;
determining, from the second request, a second tenant identifier that identifies a second of the plurality of tenants that is different from the first tenant;
determining, based on the second tenant identifier and the first type of the first machine learning application, second configuration parameters and the first graph structure;
executing the nodes of the first graph structure based on the second configuration parameters to obtain a second scoring result, wherein the executing includes executing the first of the nodes based on the second configuration parameters that causes a second machine learning model generated for the second tenant to be applied to data related to the second request; and
returning the second scoring result in response to the second request.

17. The apparatus of claim 15, wherein the operations further comprise:
receiving from a third tenant application a third request for a second machine learning application that is different from the first machine learning application;
determining, from the third request, the first tenant identifier that identifies the first of the plurality of tenants;
determining, based on the first tenant identifier and a second type of the second machine learning application, third configuration parameters and a second graph structure;
executing nodes of the second graph structure based on the third configuration parameters to obtain a third scoring result, wherein the executing includes executing a first of the nodes of the second graph structure based on the third configuration parameters that causes a third machine learning model generated for the first tenant to be applied to data related to the third request; and
returning the third scoring result in response to the third request.

18. The apparatus of claim 15, wherein the executing the first of the nodes, based on the first configuration parameters, includes:
transmitting a scoring request for a scoring service to apply the first machine learning model to the data related to the first request and obtain a fourth scoring result; and
receiving the fourth scoring result in response to the scoring request.

19. The apparatus of claim 15, wherein the nodes of the first graph structure include a dynamic node, which when executed, based on an input associated with the first request, dynamically branches out into one or more nodes from a plurality of possible nodes for the dynamic node, wherein the one or more nodes are operations of the first machine learning application that are unknown before execution of the dynamic node based on the input.

20. The apparatus of claim 15, wherein the first tenant application is a customer relationship management (CRM) application and the data related to the first request includes one or more fields of a record that is identified in the first request.

21. The apparatus of claim 20, wherein the first scoring result is based at least in part on fourth scoring results obtained from applying the first machine learning model to the data related to the first request.
